(19) United States
(12) Patent Application Publication
(10) Pub. No.: US 2012/0070047 A1
(43) Pub. Date: Mar. 22, 2012

(54) APPARATUS, METHOD AND COMPUTER READABLE STORAGE MEDIUM EMPLOYING A SPECTRALLY COLORED, HIGHLY ENHANCED IMAGING TECHNIQUE FOR ASSISTING IN THE EARLY DETECTION OF CANCEROUS TISSUES AND THE LIKE

(76) Inventor: Alfred J. Johnson, Bear Lake, MI (US)

(21) Appl. No.: 13/234,281

(22) Filed: Sep. 16, 2011

Related U.S. Application Data
(60) Provisional application No. 61/384,491, filed on Sep. 20, 2010.

(51) Int. Cl. G06K 9/00

(52) U.S. Cl. 382/128

(57) ABSTRACT

A multi spectral imaging technique and associated mathematical formula for assisting in the early detection of cancerous tissues and the like and which includes displaying a basic digital image which is reversed into a partial negative and then resaved as a second image. A third black and white product image is then mathematically generated by squaring the partial negative image and dividing by the first image, following which a three band composite color image is created utilizing spectral color guns which assign different colors to each of the images.

### CROSS-REFERENCE TO RELATED APPLICATIONS

This Application claims the benefit of U.S. Provisional Application 61/384,491 filed on Sep. 20, 2010.

### FIELD OF THE INVENTION

The present invention discloses a multi spectral imaging technique and associated mathematical formula for assisting in the early detection of cancerous tissues and the like and which includes displaying a basic digital image which is reversed into a partial negative and then resaved as a second image. A third black and white product image is then mathematically generated by squaring the partial negative image and dividing by the first image, following which a three band composite color image is created and which assigns different color gun assignments to each of the first, second and third images.

### BACKGROUND OF THE INVENTION

Multispectral imaging concerns the capture of image data at specific frequencies across the electromagnetic spectrum. Color specific wavelengths may be separated by filters or by the use of instruments that are sensitive to particular wavelengths, including light from frequencies beyond the visible light range, such as infrared. Spectral imaging can allow extraction of additional information that the human eye fails to capture with its color gun receptors for red, green and blue.

Traditional x-rays and screenings of diseases are often difficult to read, given in no small part to the varying tissue densities being difficult to determine alone with black and white imaging. Because the images are produced in black and white, sections of varying tissue density may be difficult to identify. This may prevent physicians from being able to effectively differentiate between cancerous or harmful dense tissue from non-cancerous dense tissue. As a result, many diseases may go undiagnosed, allowing them to progress beyond the point of treatability. Many individuals may pass away due to misdiagnosed, undiagnosed, and untreated diseases, underscoring the need for an effective, preventative solution is necessary.

### SUMMARY OF THE INVENTION

The present invention discloses a spectrally-colored, highly enhanced image generating apparatus, method and computer readable medium which is designed, in one non-limiting variant, to aid in the early detection of cancer and other diseases, including arterial plaque, kidney stones, gall bladder stones, and gum disorders. This invention features a color-enhancement x-ray process designed to emphasize areas of dense tissue embedded into softer normal tissues and, in one non-limiting application, may assist in imaging isolated dense, cancerous tissue, such as distinguishable from non-cancerous dense tissue, thereby allowing physicians to accurately and quickly identify and treat threatening diseases and thereby prevent diseases from growing to unmanageable and undefeatable magnitudes.

In its most basic application, the technique displays a basic digital image (B) which is reversed into a partial negative and then resaved as a second image (B1). A third black and white monochromatic product image is then mathematically generated by squaring the partial negative image and dividing by the first image (B2), following which a three band composite color image is created and which assigns different color guns to each of the first, second and third superimposed images, such as applying a red color gun to the third monochromatic image, a green color gun to the original black and white image, and a blue color gun to the second partial negative image. Additional description and applications associated with the system, process and computer readable storage medium will be referenced in further reference to the following detailed description.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 illustrates a black and white mammogram image according to the Prior Art and which appears to depict a healthy image:

FIG. 2A illustrates a spectrally colored, highly enhanced images derived from the mammogram image of FIG. 1 at original magnification;

FIG. 2B is a 4× magnified illustration of FIG. 2A and which depicts an arrangement of color bright (yellow) spots against a dark (blue) background indicating a likely metastasizing of the cancer at the time of the initial x-ray of FIG. 1, with indication arrows further depicting suspect image points of less than 0.001″;

FIG. 3 illustrates a further perspective image similar to FIG. 1 associated with a patient diagnosis of extensive breast cancer;

FIG. 4A illustrates a first magnification image produced in color of the image in FIG. 3 and utilizing the present technique which again shows bright cancerous affected areas against a darkened background;

FIG. 4B is a second 4× magnification image of the previously magnified image of FIG. 4A and highlighting the dangerous, cancerous tissue in yellow and dense, non-cancerous tissue in orange against the contrasting normal soft tissue presented in blue; and

FIG. 5 is a diagram outlining the inventive steps of the present invention.

### DETAILED DESCRIPTION OF THE PREFERRED EMBODIMENTS

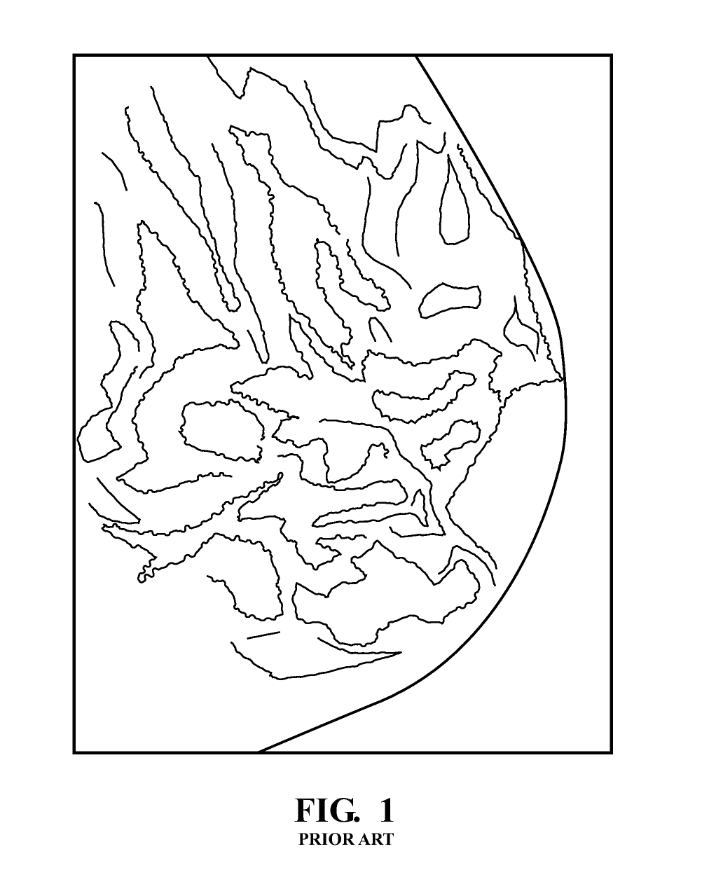

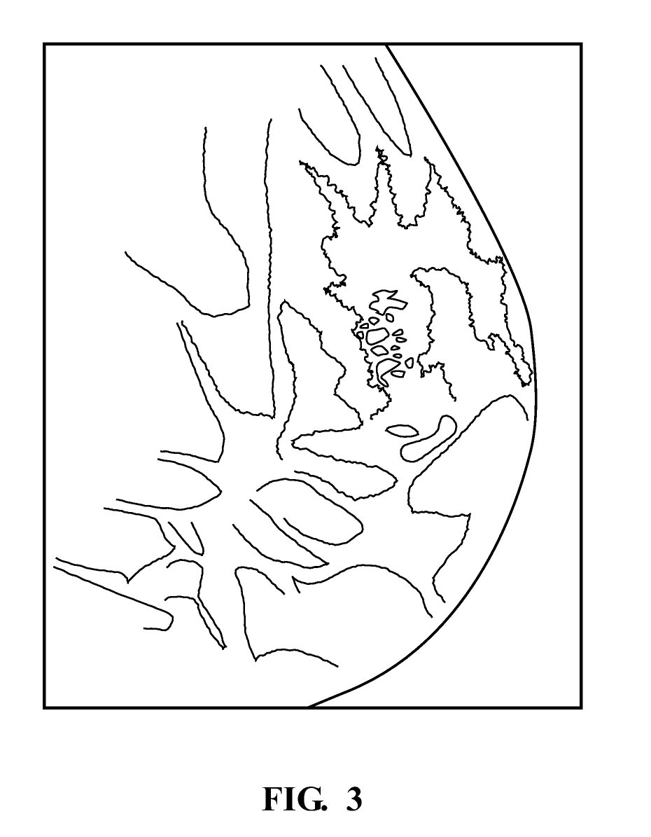

Referring now to FIGS. 1-5, the present invention discloses a spectrally colored, highly enhanced imaging technique for assisting in provide clear and discernable x-ray images and which is an improvement over prior art black and white X ray technology and other imaging techniques. In practice, the system, method and computer readable medium utilizes an x-ray system designed to produce high-contrast, color-enhanced images.

The technique is designed to produce a color spectral-like image and first generates an intermediate ratio image product that is then used as one part of a resulting three-band “color composite” image. Otherwise, it is similar to producing color images when using separate bands of multispectral data from the LANDSAT multispectral satellites. In the present instance, the operator/user must generate two of the three bands or data sets to be used; as opposed to using three separate bands of different wavelength from a multispectral sensor.

The system, method and computer readable and storable medium as described herein contemplates an operator utilizing an initial black and white digital data set image such as an x-ray, a thermal image, or any other digital image which is known in the Prior Art (see FIG. 1). This basic digital image is then reversed into a partial negative image, resulting from partially reversing the image histogram (into a revised image B2), and then saved. In use, the procedure requires certain image processing computer software such as DIMPLE, ENVI or ERDAS Imagine (etc).

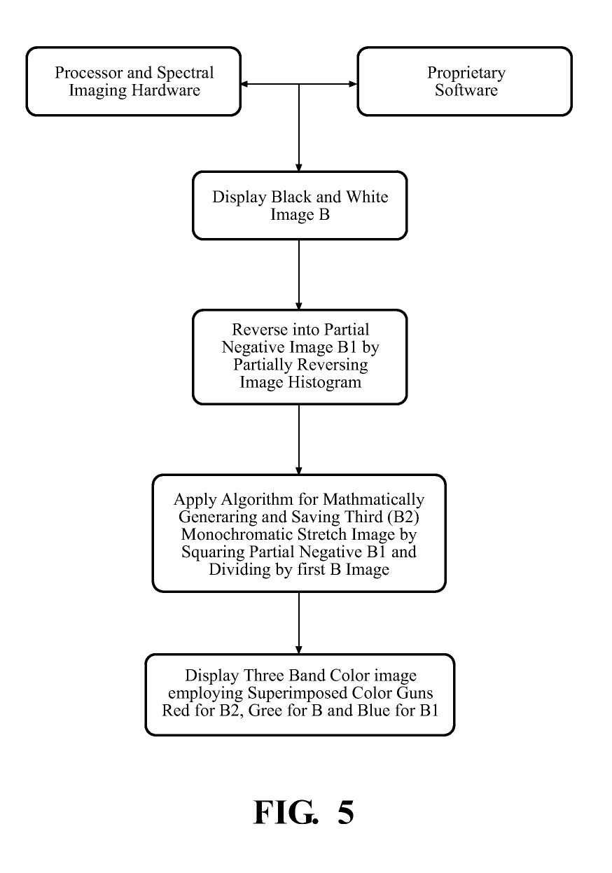

As referenced in the flow schematic of FIG. 5, and following application of the initial image conversion, an algorithm is applied for mathematically generating and save a third image (“Image 3”). This step is accomplished by squaring the partial negative image (IMAGE 2) and then dividing that product by the original black and white image (IMAGE 1), such that the associated mathematical expression is expressed as IMAGE 2 squared/IMAGE 1. The resulting black and white image PRODUCT (IMAGE 3) is also saved to be used as one component of the final color three-band image product. This procedural second step can also be accomplished using a range of exponent powers for the ratio depending on level(s) of detail and contrast desired. Such as for use in detection of abscesses, square on partial negative, divide by full positive, and present that result in red. Additionally, present the full negative in green and the full positive in blue, such that the infected area will appear in red and which will add this same information to.

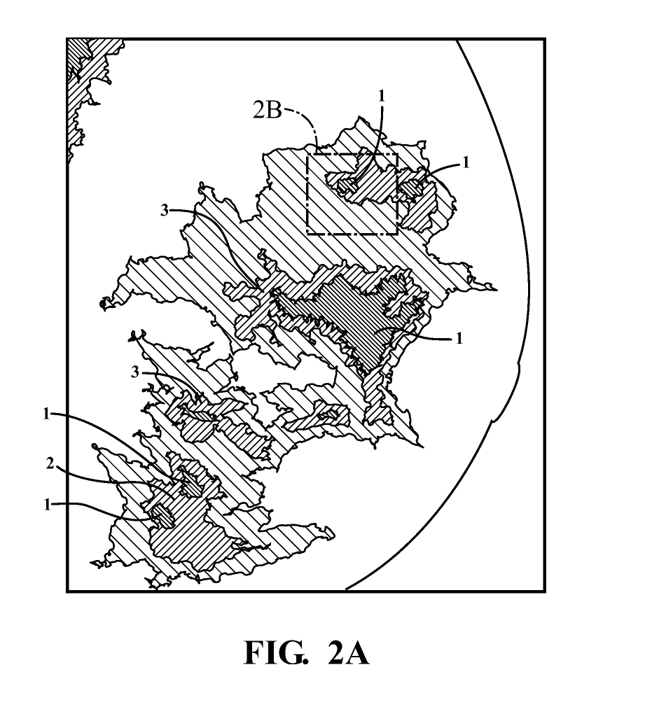

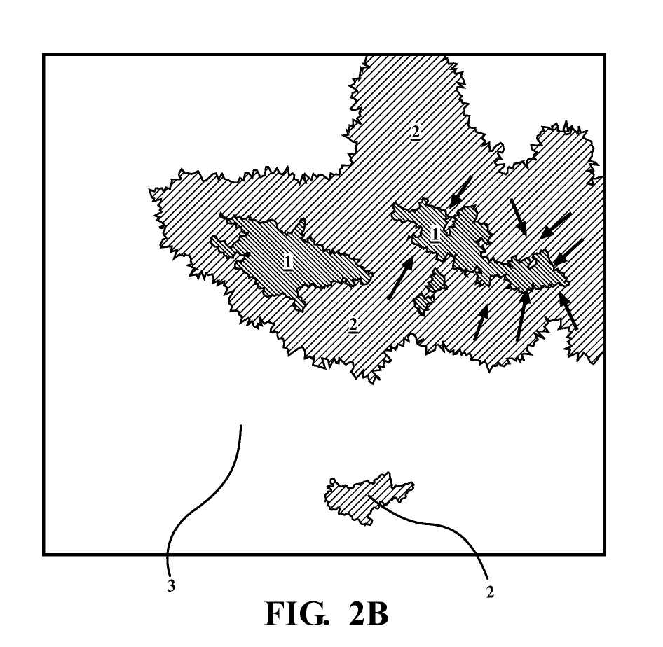

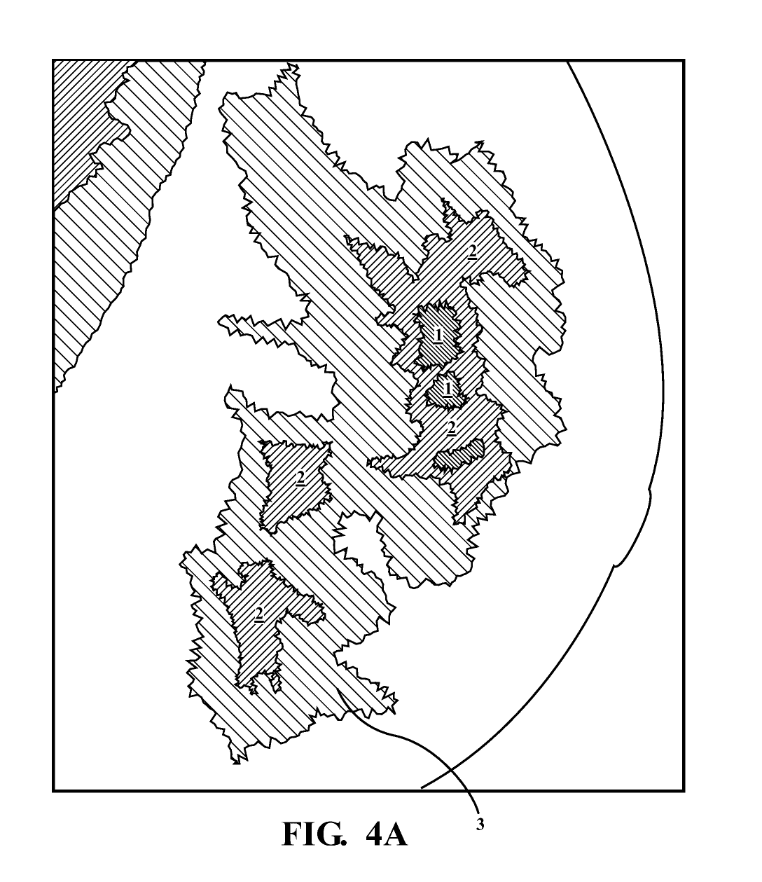

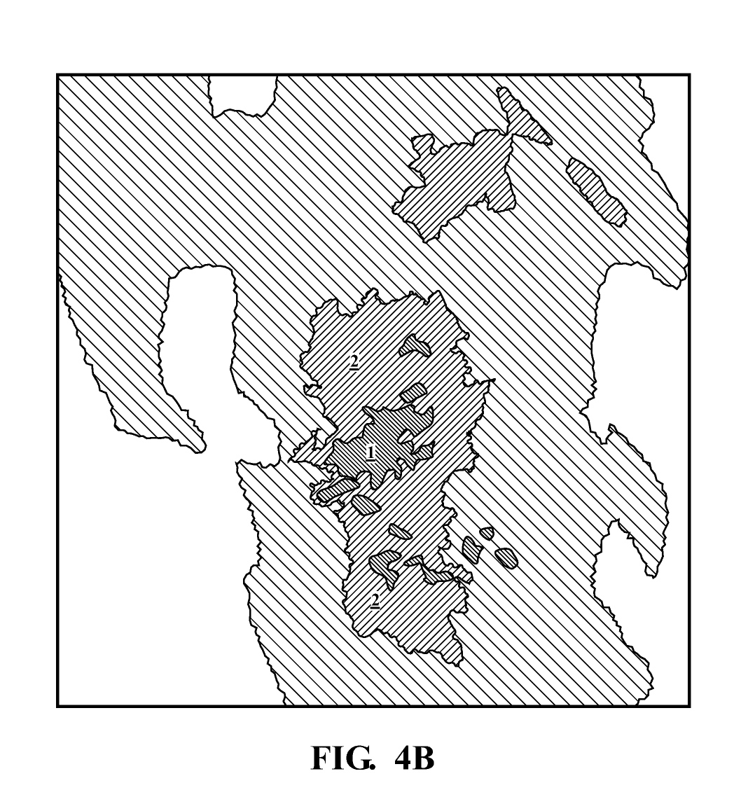

In a final step, the processor and associated software produces a three color superimposed image such as is depicted in each of FIGS. 2A, 2B, 4A and 4B, and which can use any desired color selections. In one non-limiting embodiment, color gun assignments include a first red gun applied to the third monochromatic image B2, a green gun applied to the first basic image B and a blue gun applied to the partial negative B1 image (this effectively illuminating the reversed white background portion of the reciprocal image and as is depicted the substantially blue background evident in the color drawings.

The partial negative in Step 1 for example was originally created by using an approximate 80 percent straight-line reversal stretch in the Image 1 histogram. Further refinements of the procedure include generating non-linear stretches designed to enhance or highlight specific features (or brightness levels) in the image for detecting obscure features. Further, while other stretches/steps are optional, all are considered as part of this technique, and hence, also fall under this patent including optional stretches for original and mathematically enhanced data sets.

The KEY BASIC FORMULA to produce (and ultimately display) the spectrally colored, highly enhanced image products (SCHEIP color images) from a single black & white image is again represented by the mathematical formula (B1)*B1)/B2 which represents squaring of the partial negative image (B1) and dividing by the first image (B2). This approach is believed applicable to any B&W image originating from practically any source and serves to increase the universal applicability of the imaging technique. It is further envisioned and understood that, beyond the particular formula described herein, additional user custom generated stretches can be devised and applied to any or all of the components to facilitate enhancement of an unlimited number of features, for example dental infections can be displayed using a formula computed by squaring one partial negative, dividing by the full positive, and presenting the result in red. Additionally, the full negative can be presented in green with the full positive in blue, resulting in the infected area appearing in red.

Component Descriptions

B=Any Black & White image (Mammogram for example)

B1=A partial negative of the B&W image (with N value(s) end points for Linear and/or Non-linear stretches creating the partial negative image)

B2=The Original B&W image with any stretch desired (Histogram Equalization often satisfactory)

Display Sequence for the Scheip (3-Band) Color Image

RED gun=the (B1*B1)/B2 product image (SAVED IN A FILE FOR THIS USE)

GREEN gun=The Original B&K image with selected stretch.

BLUE gun=The Partial Negative image generated as Band 1 (above).

Generalized Form of the Patent's Formula

The following mathematical representations in use with the present technique are again restated as follows:

m n

B1/B2 WHERE: m>0 and n>0 and WHERE: m is usually positive and n is usually positive.

—OR—

2 1

B1²/B2=B3 WHERE: B1 is a partial negative (w/DN values positive); B2 is the original positive; and B3 is the positive result and with all to be used as components of the displayed image.

Image Histogram Forms Included

B1 and B2 Include each of the Following:

1. Positive Histograms

2. Negative Histograms

3. Partial-Negative Histograms

4. Including all non-linear forms of the above

In use, and applying the above algorithm and associated mathematical formula, application of this process with standard black and white mammography films, for example, depicts likely areas of concern or interest not limited to cancer cells or tumor areas in a bright yellow color (depicted at 1 in reference to the third monochrome image component created and saved, and in reference to designated mathematical or algorithmic enhanced or stimulated locations in each of FIGS. 2A, 2B, 4A and 4B), with surrounding proximately or slightly less dense tissue or other material in shades of orange 2 (depicting the basic digital image color component) and blue 3 (depicting the second image created by the partial negative histogram). The visibility of the stipulated areas 1 illustrates the major advantages of the SCHEIP apparatus, process and computer readable storage medium and can assist in revealing early stage cancerous growths which may not be as readily evident in standard digital x-rays. The present technique concurrently helps to illuminate potential or likely cancerous cells in designated locations 1, and as opposed to providing false positive readings of denser healthier tissue otherwise mimicking the aspects of cancerous growths.

According to documented research, the red/orange/yellow part of the color spectrum is the region where the human eye is most sensitive to color and shading differences. This feature makes the colorizing technique described especially suited for visual interpretation by trained x-ray analysts. However, it is considered essential that these analysts be trained and color vision tested to ensure accurate analysis.

The image processing technique can be used to color enhance nearly any digital image or a film image that is digitally scanned. In application, the colors seen are not arbitrarily assigned, but are the result of the sequence of assigning colors to the data sets when displaying the image in color on a computer screen, and/or a result of different tissue/material densities. The colors can also be changed by varying the amount the partial negative is changed from the positive, and/or by changing the red, green, blue color assignments for the composite image. Most current techniques producing colored medical type images use a technique called density slicing.

The image gray levels are usually arbitrarily assigned a different color. The SCHEIP image processing technique however, captures the subtle shading differences that exist in different materials, or in this case, different densities of tissue. Such an image aids the analyst in detecting the abnormality, assessing its extent, degree of severity, and ultimately in measuring its size. The size determination can be easily made by doing a computer mapping of a given color as the result of using a “trained classification” procedure. This procedure shows the area on the image and provides a pixel count of the matching pixels. In application, it has been found that the image processing technique is superior to arbitrarily assigning colors to densities of a single black and white image and captures the mathematically generated/enhanced, subtle differences in tissue/material content, and automatically displays them in colors best suited for human visual interpretation.

The effect of colorization has been shown to significantly increase a radiologist's ability to interpret images. This factor has been especially important to radiologists in the medical field. A 2002 article in the Journal of the International Society for Optical Engineering noted that an observer can only detect an average of 140 levels of grayscale. In contrast, an optimally colorized image can allow a user to distinguish 250 to 1000 different levels, hence, increasing potential image feature detection by 2-7 times. Interviews with radiologists have increasingly highlighted their concerns of missing something and then being held liable and subject to lawsuits.

The images can be presented in orange and yellow hues, and which have been found to be among the most noticeable colors to the human eye. Areas of highly-concentrated density may further be presented in yellow, allowing the worst problem areas to be quickly identified, while areas of lower density can be presented in orange. Normal soft tissues can be presented in blue for visible isolation of healthy versus diseased areas. The present technique can also be employed for detecting dense tissue (e.g. cancer) features as small as 100^{th} of an inch (this corresponding to the 4× magnified size of the yellow dots depicted in FIG. 2B).

This technology may be achieved by combing analytical techniques from four separate disciplines: standard visual imagery analysis methods, algorithm development technology, environmental change detection analysis, and color multi-spectral information analysis. The invention can be used for early detection and diagnosis of cancer, arterial plaque, kidney stones, gall bladder stones, gum disorders, and other diseases. The present technique further enables a lower radiation level to be employed in the generation of the basic digital image B than which is normally utilized, and owing to the ability of the imaging technique described herein to compensate by providing enhanced detail in the eventually created three color coded image.

Other applications, not necessarily limited to medical applications, can also include those for the veterinary sciences including detection of porcupine quills in dogs and other animals, as well as for other non-medical industrial uses including detection of anomalies or inconsistencies in castings or corrosion in piping and storage tanks.

Among the applications to which the present invention is applicable include each of:
early detection, diagnosis, treatment and monitoring of breast and other types of cancer including smaller cancer cell formations;
fewer medical malpractice suits resulting therefrom
fewer x-rays required thereby reducing radiation of initial imaging procedure;
fewer x-rays required;
detection and monitoring of osteoporosis;
detection and monitoring of plaque in heart and arteries;
detecting soft tissue anomalies where standard x-rays are not normally effective including as a possible substitute for many MRIs (magnetic resonance imagings);
easier detection and analysis of broken bones;
ultrasound imaging to assist in detecting possible birth defects;
applicable to MRI's, sonograms, thermal imagery and acoustical images;
veterinarian uses for soft tissue injuries and detection of porcupine quills in dogs;
dental x-rays for more easily detecting decay and abscess formation;
non-medical uses such as inspecting or monitoring of weld integrity, existence of corrosion on all types of tanks, pipes, valves, etc., using x-ray, thermal, acoustical and most other types of imaging products;
detection and monitoring of defects in industrial castings;
authentification of paintings and historical artifacts;
homeland security checks of passenger baggage and shipping containers.

Having described my invention, other and additional preferred embodiments will become apparent to those skilled in the art to which it pertains, and without deviating from the scope of the appended claims.

I claim:

1. A system for manipulating an initial digital image in order to create a multi-color composite image depicting areas of varying density, comprising:
a processor including a display and into which is inputted the digital image;
a software program incorporated into said processor and which creates an image histogram by reversing and saving the digital image as a partial negative image;
said software and processor applying a mathematical formula for generating and saving a third monochrome image; and
combining and displaying a three band color image including said monochrome image as a first color component, said basic digital image as a second color component, and said partial negative image as a third color component.

2. The system as described in claim 1, further comprising said software program and processor generating said third monochrome image by squaring said partial negative image and dividing by said basic digital image.

3. The system as described in claim 1, said partial negative image and third monochrome image further comprising at least one of a positive histogram, a negative histogram, a partial-negative histogram and any other non-linear form or expression.

4. A method for manipulating an initial digital image in order to create a multi-color composite image depicting areas of varying density, comprising the steps of:
displaying a digital image utilizing a software program incorporated into a processor;
creating an image histogram by reversing and saving the digital image as a partial negative image;
applying a mathematical formula for generating and saving a third monochrome image; and
combining and displaying a three band color image including the monochrome image as a first color component, the basic digital image as a second color component, and the partial negative image as a third color component.

5. The method as described in claim 4, further comprising the step of generating the third monochrome image by squaring said partial negative image and dividing by the basic digital image.

6. The method as described in claim 4, further comprising the step of the partial negative image and third monochrome image being a positive value.

7. A computer readable storage medium including a processor and software program for manipulating an initial digital image in order to create a multi-color composite image depicting areas of varying density, comprising:
a first subroutine for inputting a digital image;
a second subroutine for creating an image histogram by reversing and saving the digital image as a partial negative image;
a third subroutine for applying a mathematical formula for generating and saving a third monochrome image; and
a fourth subroutine for combining and displaying a three band superimposed color image including the monochrome image as a first color component, the basic digital image as a second color component, and the partial negative image as a third color component.

8. The computer readable storage medium as described in claim 7, said third subroutine for generating the third monochrome image further comprising applying a mathematical formula of a square of the partial negative image divided by the basic digital image.

9. The computer readable storage medium as described in claim 7, said second and third subroutines further comprising the partial negative image and third monochrome image having a positive value.

10. The computer readable storage medium as described in claim 7, said second and third subroutines further comprising the partial negative image and third monochrome image including at least one of a positive histogram, a negative histogram, a partial-negative histogram and any other non-linear form or expression.
